(19) United States
(12) Patent Application Publication
(10) Pub. No.: US 2010/0300986 A1
(43) Pub. Date: Dec. 2, 2010

(54) WELL FILTER

(76) Inventor: Harout Ohanesian, Laguna Niguel, CA (US)

Correspondence Address: Myers Andras Sherman LLP, 19900 MacArthur Blvd., Suite 1150, Irvine, CA, 92612, US

(21) Appl. No.: 12/472,815

(22) Filed: May 27, 2009

(51) Int. Cl. C02F 1/00

(52) U.S. Cl. 210/767; 210/170.07

(57) ABSTRACT

A well filtration device includes a first pipe including a first end having a first thickness and first opening diameter, a second end having a second thickness and a second opening diameter, and many openings through a portion of the first pipe. A second pipe includes a first end having a third thickness and a third opening diameter, a second end having the third thickness and the third opening diameter, many openings throughout the second pipe, and reinforcement portions throughout the second pipe. The second pipe is configured to attach over the first pipe to allow filtration of a liquid.

### BACKGROUND

1. Field of the Invention

The present invention relates generally to filtration, and more specifically to well water filtration devices, systems and methods.

2. Description of the Related Art

The use of screened or slotted pipes for the extraction of water from water wells is well known. Screened or slotted pipes are presently being made from a variety of raw materials. These raw material formats that are processed to form a pipe product, and then slotted or screened for use in water extraction all have disadvantages. Metal pipes used in this manner tend to be heavy and deteriorate quickly in the water well environment. This can lead to a potential weakness in the vertical pipe column or allow detritus to build up on the rust and thus harbor potential bacteria. Screened or slotted plastic pipes use a single pipe with a screened or slotted pipe wall tend to allow external materials smaller than the screen or slot size to pass through into the water distribution system.

Screening or slotting of pipes develops a tradeoff between making many cuts as possible to allow significant water flow through the slots, while at the same time not reducing the strength of the pipe by decreasing the amount of material in its construction and minimizing the slot size so as not to allow external material to pass through into the water distribution system.

### BRIEF SUMMARY

One aspect of an embodiment of the invention includes a well filtration device comprising a first pipe (inner base pipe) including a first end having a first thickness and first opening diameter, a second end having a second thickness and a second opening diameter, and many openings through a portion of the first pipe. The well filtration device includes a second pipe (outer cover pipe) comprising a first end having a third thickness and a third opening diameter, a second end having the third thickness and the third opening diameter, many openings throughout the second pipe, and reinforcement portions throughout the second pipe. The second pipe (outer cover pipe) is configured to attach over the first pipe (inner base pipe) to allow filtration of a liquid.

Another aspect of an embodiment of the invention provides a well filtration system. The system comprising many first pipes (inner base pipes). Each first pipe (inner base pipe) comprises a first end having a first thickness and first opening diameter, a second end having a second thickness and a second opening diameter, and many openings through a portion of the first pipe. The system further comprising many second pipes (outer cover pipes). Each second pipe (outer cover pipe) comprising a first end having a third thickness and a third opening diameter, a second end having the third thickness and the third opening diameter, many openings throughout the second pipe (outer cover pipe), and reinforcement portions throughout the second pipe (outer cover pipe). The second pipe (outer cover pipe) is configured to couple over the first pipe (inner base pipe) to allow filtration of a liquid.

Yet another aspect of an embodiment of the invention provides a well filtration method. The method includes forming many filtration units by attaching many first pipes (inner base pipes) with many second pipes (outer cover pipes). The filtration units are connected together to form a contiguous filtration pipe. A guide shoe is connected to a first end of the filtration pipe. The filtration pipe is inserted into a well containing liquid. A suction means is attached to a second end of the filtration pipe. The liquid is filtered through the filtration pipe. Each first pipe (inner base pipe) includes a first end having a first thickness and first opening diameter, a second end having a second thickness and a second opening diameter, and many openings through a portion of the first pipe. Each second pipe (outer cover pipe) includes a first end having a third thickness and a third opening diameter, a second end having the third thickness and the third opening diameter, many openings throughout the second pipe (outer cover pipe), and reinforcement portions throughout the second pipe (outer cover pipe).

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates the cross section elevation running along centerline and end elevation cross-section for an inner base pipe according to one embodiment of the invention;

FIG. 2 illustrates the cross section elevation running along centerline and end elevation cross-section for an outer cover pipe according to one embodiment of the invention;

FIG. 3 illustrates an end elevation cross section running along the center line across a completely formed pipe filter system inclusive of inner base pipe and external cover pipe according to one embodiment of the invention;

FIG. 4 illustrates a cross section elevation running along the center line across a completely formed pipe filter system inclusive of inner base pipe and external pipe cover according to one embodiment of the invention;

FIG. 5 illustrates a cross sectional view of an external cover pipe running at end elevation according to one embodiment of the invention;

FIG. 6 illustrates an enlarged cross sectional view of an internal base pipe running at end elevation according to an embodiment of the invention;

FIG. 7 illustrates an isolated view of a female threaded portion of an internal base pipe connected with a male threaded portion of another internal base pipe according to an embodiment of the invention;

FIG. 8 illustrates an enlarged segmental cross sectional view of completely formed pipe filter system according to an embodiment of the invention;

FIG. 9 illustrates a side cross section view of a well filtering system running along center line according to an embodiment of the invention; and

FIG. 10 illustrates a block diagram of a well filtering process for according to an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc. The description may disclose several preferred embodiments for well filtration systems, devices, and methods, as well as operation and/or component parts thereof. While the following description will be described in terms of well filtration devices, systems and methods for clarity and placing the invention in context, it should be kept in mind that the teachings herein may have broad application to all types of systems, devices and applications.

One embodiment of the invention provides a well filtration device comprising a first pipe (inner base pipe) including a first end having a first thickness and first opening diameter, a second end having a second thickness and a second opening diameter, and many openings through a portion of the first pipe. The well filtration device includes a second pipe (outer cover pipe) comprising a first end having a third thickness and a third opening diameter, a second end having the third thickness and the third opening diameter, many openings throughout the second pipe, and reinforcement portions throughout the second pipe (outer cover pipe). The second pipe (outer cover pipe) is configured to attach over the first pipe (inner base pipe) to allow filtration of a liquid.

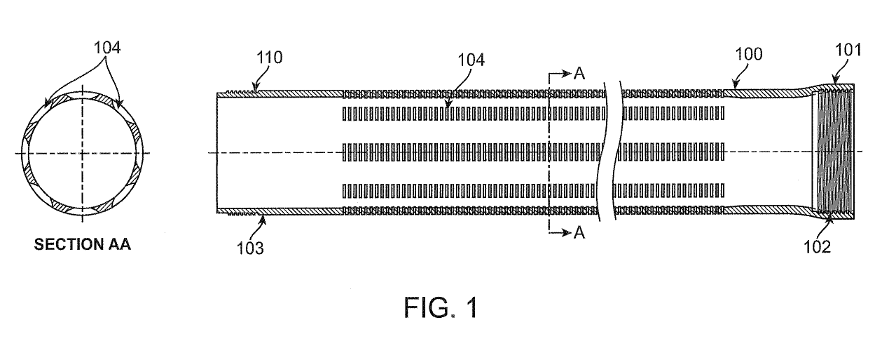

FIG. 1 illustrates a cross section elevation running along centerline and end elevation cross-section A-A for an inner base pipe according to one embodiment of the invention. The internal base pipe 100 is made of a polymer according to one embodiment of the invention. In another embodiment of the invention, the internal base pipe 100 is preferably extruded from a blue Unplasticised Polyvinyl Chloride (UPVC) compound with specific gravity of about 1.44 and comprises of a single pipe having a length in the range of 2.1-2.75 meters with a duly strengthened end 101 having a wall thickness greater than the other end 103. In one embodiment of the invention, end 101 has a wall thickness in the range of 16.0 mm to 30.0 mm, and end 103 has a wall thickness in the range of 10.00 mm to 27.0 mm according to the size of pipe filter system. In other embodiments of the invention the internal base pipe 100 diameter and wall thicknesses may be variable dimensions derived from water well depth and diameter parameters and be duly strengthened. It should be noted that other similar material may be used for the inner base pipe 100, such as Steel, GRP (Glass Fiber Reinforced Thermosetting Plastics), PP (Propylene and Polypropylene) plastic-lined, ABS (Acrylonitrile Butadiene Styrene), etc. Note that while the base pipe 100 is shown in a cylindrical shape with a circular diameter, other diameter shapes can be used such as oval, polygonal, etc.

In one embodiment of the invention, end 101 includes a female socket, where the outer section of the socket is in the range of 100-150 mm in length, and preferably 130 mm in length. In this embodiment of the invention, the formed female socket at end 101 is cut internally in the socket with a thread 102. In this embodiment of the invention the dimensions of the thread at end 101 may be any dimension taken from a variety of international specifications for such or from specific parameters designed to enhance tensile and compression strength performance.

At end 103 of the inner base pipe 100 a thread 110 is cut on the outer portion of the inner base pipe 100. The thread on the end 103 is configured to allow other inner pipes 100 to be connected (i.e., screwed) together to form a tight and resolute joint. In one embodiment of the invention the thread 110 at end 103 is in the range of 100-150 mm in length, and preferably 130 mm in length, and sized to match the thread 102 of end 101. The inner base pipe 100 is then drilled, screened or slotted in such a manner as to form a set pattern of cuts 104, which allow significant water throughput while maintaining maximum integrity of pipe tensile and compression strength. In one embodiment of the invention slot cut dimensions in length and width can be set to a variety of sizes to accommodate water well parameters and water flow. In some embodiments of the invention, screen or slot 104 patterns may be vertical, horizontal, a combination of vertical and horizontal, vary in shape (e.g., square, rectangular, polygonal, oval, round, etc.), vary in diameter, vary in length, vary in size, vary in number of slots, vary in spacing between slots, vary in groupings of patterns, etc. depending on well parameters. In one embodiment of the invention the slots 104 are sized to maintain maximum water throughput while retaining strength.

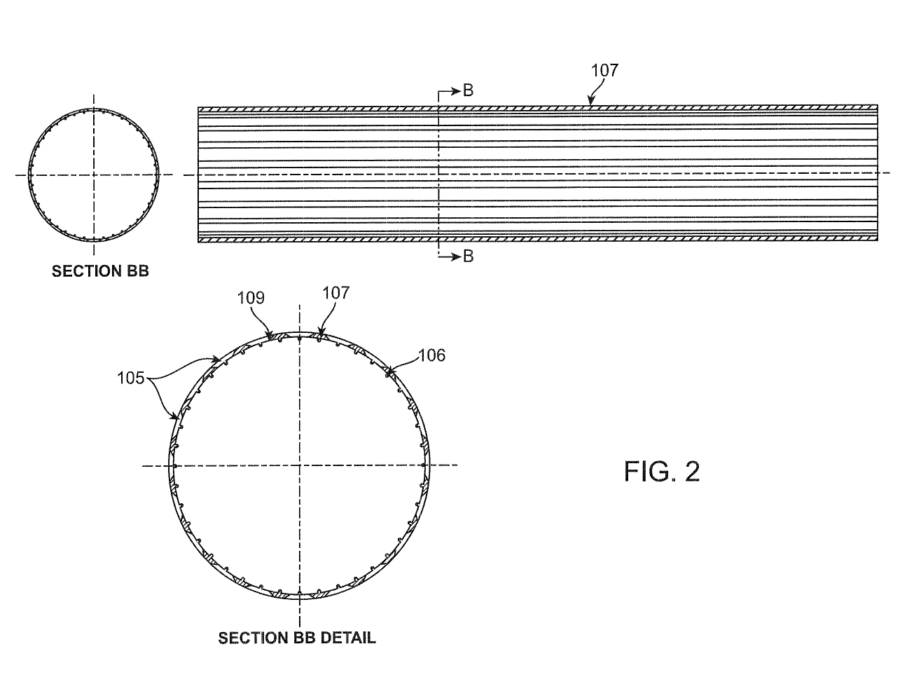

FIG. 2 illustrates the cross section elevation running along centerline and end elevation cross-section B-B for an outer cover pipe 107 according to one embodiment of the invention. In one embodiment of the invention the external covering pipe 107 is extruded in same manner and material as the inner base pipe 100 and then screened or slotted with openings in such a manner as to form a set pattern of cuts 105 are sized to maintain finest filtering characteristics against external particulate content for particular water well and allowing maximum water throughput while retaining integral strength of handling with the help of reinforcement ribs 106. In one embodiment of the invention, the ribs 106 have a thickness in the range of 3.0 to 7.0 mm and height that maintain the annular gap in the range of 4.5 to 10.0 mm according to size of pipe filter system. In one embodiment of the invention the length of the external cover pipe 107 is such that it substantially covers all of the screened or slotted section 104, and also incorporates an overlap on to the solid portions (i.e., not screen or slots on these portions) at each end of inner base pipe 100. In one embodiment of the invention the ribs 106 may be cylindrical in shape. In other embodiments of the invention, the ribs 106 may have other shapes, such as circular, polygonal, rectangular, square, etc.

The dimension of length and width of slots or cuts 105 can be set to a variety of sizes to accommodate water well filter parameter and water flow. In some embodiments of the invention, the screen or slot 105 pattern may be vertical, horizontal, a combination of vertical and horizontal, vary in shape (e.g., square, rectangular, polygonal, oval, etc.), vary in diameter, vary in length, vary in size, vary in number of slots, vary in spacing between slots, vary in pattern grouping, etc. depending on well filtering parameters. In one embodiment of the invention the slots 105 are sized to maintain the finest filter characteristics against external particulate contents for the particular well.

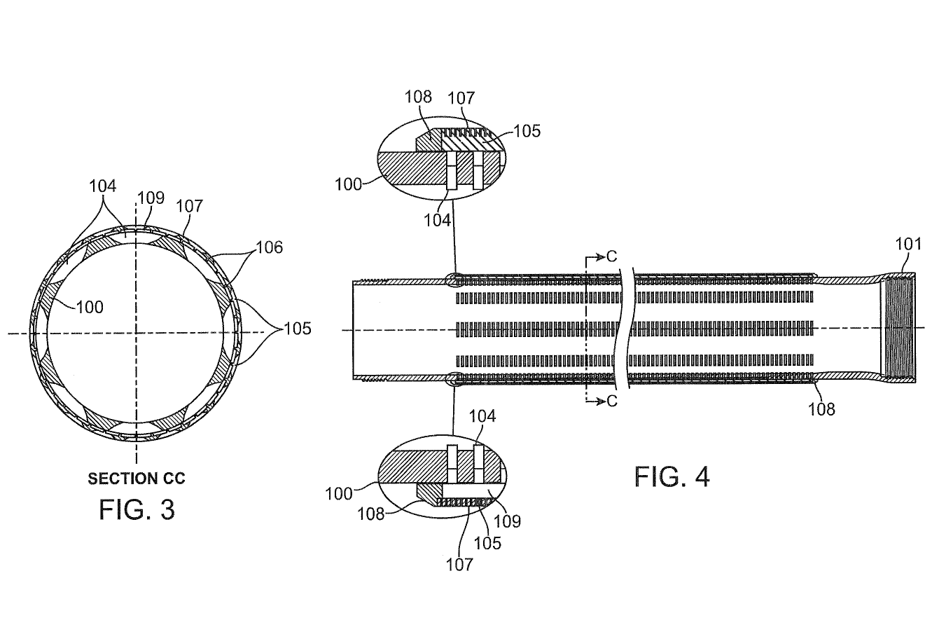

FIG. 3 illustrates an end elevation cross section running along the center line across a completely formed pipe filter system including inner base pipe 100 and outer cover pipe 107 according to one embodiment of the invention.

FIG. 4 illustrates a side cross section elevation view along the center line across a completely formed pipe filter system inclusive of inner base pipe 100, and external pipe cover 107 according to one embodiment of the invention.

In one embodiment of the invention the external covering pipe 107 has reinforcement ribs 106 that may have an internal size that slides over internal base pipe 100 creating an equidistant annular gap 109 all around the internal base pipe 100 and at the same time add support for external cover pipe 107 against internal base pipe 100 in order to handle external loads and pressure within the well assembly. The internal diameter of external cover pipe 107 reinforcement ribs 106 is set at a dimension so that the external cover pipe 107 slides over the inner base pipe 100 with an equidistant gap 109 all around the inner base pipe 100. The gap 109 is then sealed at both ends with closing end rings 108. Thus threaded, screened or slotted and installed pipes are then screwed together and placed into a water well to form a strong pipe column which is gradually lowered down into the well until the formed pipe reaches the required depth. In one embodiment of the invention the end rings 108 may be welded onto the inner base pipe 100 and the external cover pipe 107 to seal the ends of the external cover pipe 107 and may also further attach the external cover pipe 107 to the inner base pipe 100. In one embodiment of the invention the end rings 108 may be made of compounded UPVC material of same specific gravity as these pipes. In other embodiments of the invention, the end rings 108 may be made of other similar materials, such as Steel, GRP, ABS, PP, etc. as per material chosen for internal base pipe and external cover pipe.

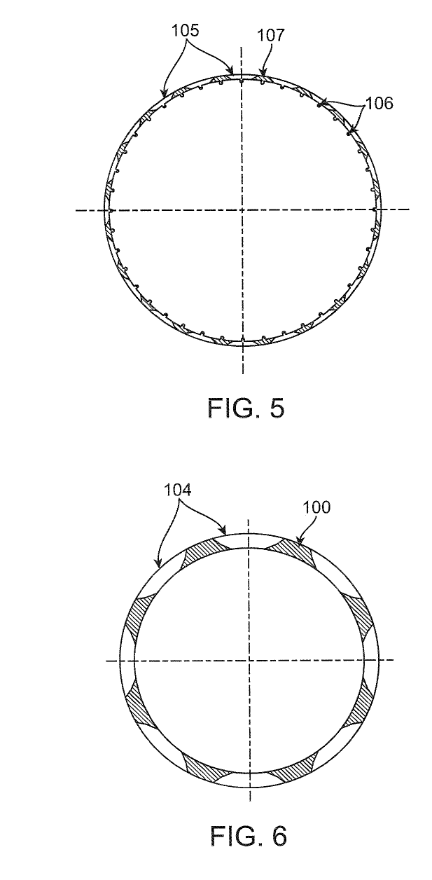

FIG. 5 illustrates a cross sectional view of an external cover pipe 107 running at end elevation according to one embodiment of the invention. As illustrated, the ribs 106 have a dimension that spaces the outer cover pipe 107 a distance from the inner base pipe 100 to form the gap 109 (see FIGS. 3-4).

FIG. 6 illustrates an enlarged cross sectional view of an internal base pipe 100 running at end elevation according to an embodiment of the invention.

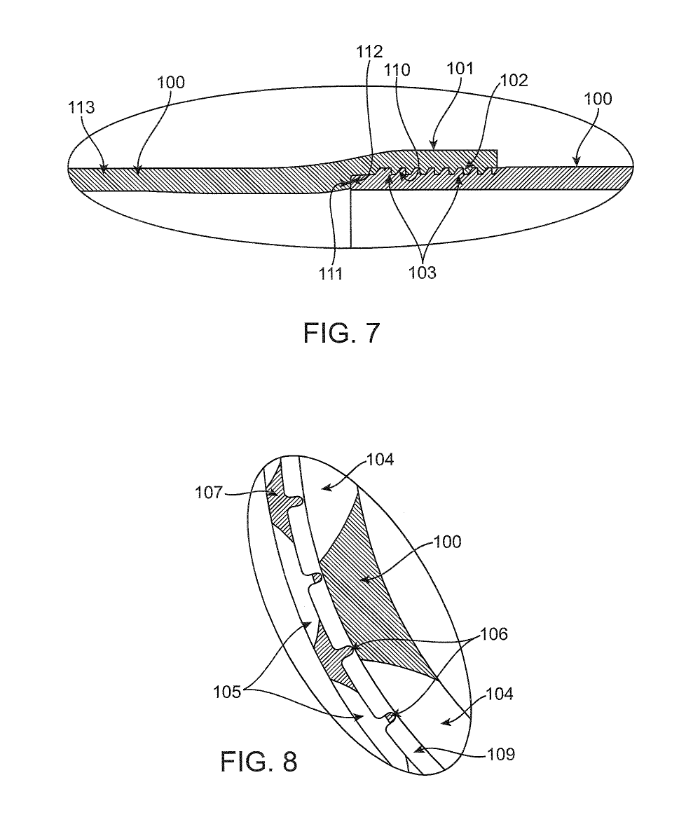

FIG. 7 illustrates an isolated view of a female threaded portion 102 located at end 101 of an internal base pipe 100 connected with a male threaded portion of end 103 of another internal base pipe 100 according to an embodiment of the invention. As illustrated, the end 101 of the inner base pipe 100 has a wall thickness greater than the other portions of the inner base pipe 100, such as portion 113 and end 103. FIG. 7 also illustrates the joint characteristic of one internal base pipe 100 male side with another internal base pipe 100 female side through portion 111 of end 101 and portion 112 of end 103 by resting over one another, with out any gap, to enable compression load bearing characteristic for assembly into deep well.

FIG. 8 illustrates an enlarged cross sectional view of an inner base pipe 100 with an external cover pipe 107 connected according to an embodiment of the invention. As illustrated, the gap 109 is formed by the spacing created by ribs 106.

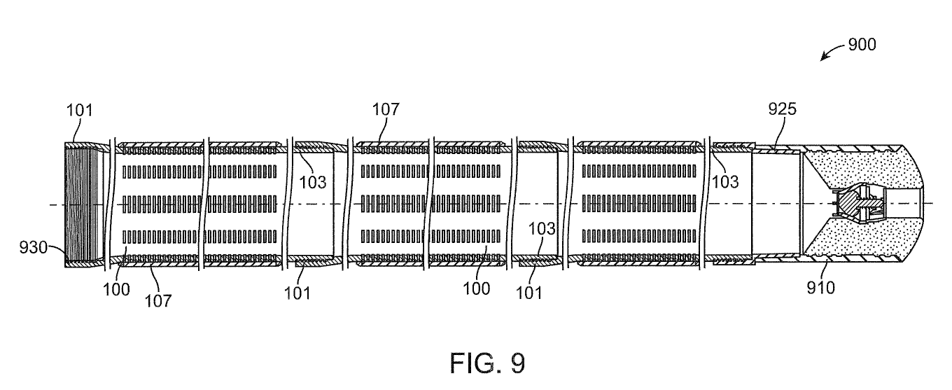

FIG. 9 illustrates a side view of a well filtering system 900 according to an embodiment of the invention. As illustrated, multiple inner base pipes 100 are attached with outer cover pipe 107 to form finished filter units. Multiple filter units are connected together via the female thread portion of an end 101 coupled with a male thread portion of an end 103 to result in a desired length of the complete filter pipe system. A guide shoe 910 is attached by means of a stainless steel connector 925 of the filter system 900 at one end 103 of an inner base pipe 100 according to one embodiment of the invention. A suction means (e.g., a pump system, etc.) is connected to the other end 930 to draw water through the filter system 900 to filter the well water.

In one embodiment of the invention, well water containing particulate matter (not shown) will encounter the outer cover pipe 107 slots 105. The slots 105 will prevent even minute particles from entering through the outer cover pipe 107. As filtered water enters through the outer cover pipe 107, the annular gap 109 allows it to accumulate and maintain water volume sufficient enough for water throughput according to a particular water well environment. Unlike prior art filters which only include one pipe wall that has to filter the water allowing water throughput according to a water well environment through slotting of this pipe forces one to develop a trade off with its strength, the water well filter system 900 comprises fine level of filtering between the exterior of the outer cover pipe 107 and the interior of the inner base pipe 100 with maximum water throughput while still retaining its strength for assembly into deep water well. Moreover, the outer cover pipe filtering design of water well filter system 900 allows its fine size slot machining, thus filtering of even minute external particle while retaining the system strength jointly with inner base pipe 100 is achieved.

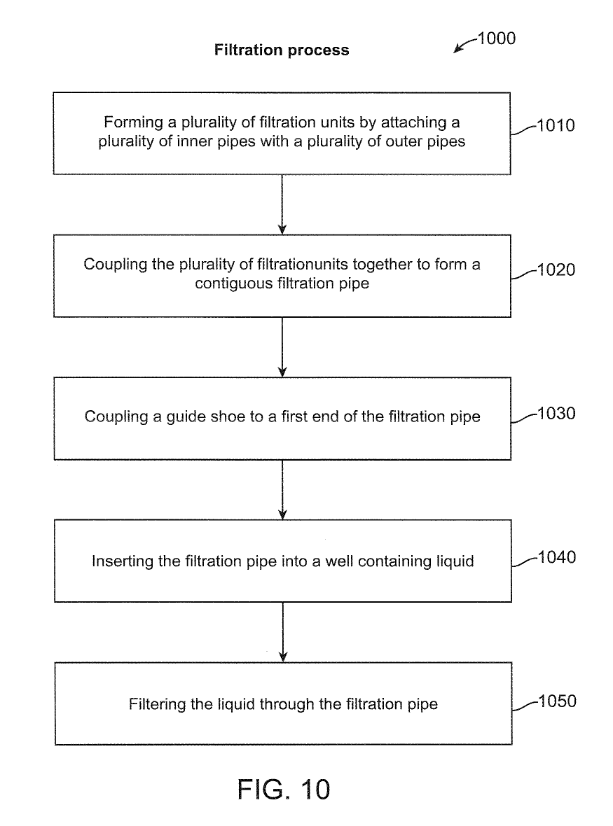

FIG. 10 illustrates a block diagram of a well filtration process 1000. Process 1000 begins with block 1010 with forming filtration units by attaching inner base pipes 100 with external cover pipes 107. In block 1020, the filtration units are connected together to form a contiguous filtration pipe. Process 1000 continues with block 1030 where a guide shoe (e.g., portion 910 shown in FIG. 9) is connected to a stainless steel connector at first end 103 (e.g., end 925 shown in FIG. 9) of the filtration pipe.

In block 1040 the filtration pipe (e.g., filtration pipe system 900 shown in FIG. 9) is inserted into a well containing liquid (not shown). Process 1000 continues with block 1050 where the liquid in the well is filtered through the filtration pipe using a suctions means, such as a pump, or other suction device.

The embodiments of the invention overcome the disadvantages of the prior art by combing pipe strength, light weight materials, significant water flow throughout, fine external material filtering qualities, long life, the reduction of potential detritus buildup due to pipe deterioration and the ability to be formed from a base material that can be recycled.

Therefore, it can be appreciated that the water well filter 1010 provides more extensive and effective filtering, which leads to cleaner water than prior art filters. Since the outer pipe 107, inner pipe 100, sealing rings 108 all comprise of UPVC, the various components will not mix or react chemically with each other. Also, since UPVC can be recycled, the use of UPVC leads to greater efficiency and less expense in the manufacturing of the water well filters 1010. Furthermore, UPVC will not react or undergo detritus as a result of prolonged contact with water. Being low in density, UPVC is lighter in weight, and yet more durable, than metal, thus making the water well filter 1010 easier to use and longer lasting

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A well filtration device comprising:
a first pipe comprising:
a first end having a first thickness and first opening diameter;
a second end having a second thickness and a second opening diameter, and
a plurality of openings through a portion of the first pipe; and
a second pipe comprising:
a first end having a third thickness and a third opening diameter;
a second end having the third thickness and the third opening diameter;
a plurality of openings throughout the second pipe; and
a plurality of reinforcement portions throughout the second pipe;
wherein the second pipe is configured to couple over the first pipe to allow filtration of a liquid.

2. The well filtration device of claim 1, wherein the first end of the first pipe is a female end including threads along an inner portion of the first pipe.

3. The well filtration device of claim 2, wherein the second end of the first pipe is a male end including threads along an outer portion of the first pipe.

4. The well filtration device of claim 3, wherein the plurality of openings of the second pipe are filtration slots that allow a liquid outside of the second pipe to pass through to the inner portion of the first pipe.

5. The well filtration device of claim 4, wherein the reinforcement portions are ribs along a length of an inner portion of the second pipe having a thickness such that a gap is formed between the first pipe and the second pipe when the first pipe is placed within the second pipe.

6. The well filtration device of claim 1, wherein the first pipe is an internal base pipe and the second pipe is an outer cover pipe, and the outer cover pipe is configured to couple over the internal base pipe that includes finely machined slots for filtering minute external particulates in a deep well without trading off strength for assembly into the deep well.

7. The well filtration device of claim 5, further comprising:
a guide shoe configured to be coupled to the second end.

8. The well filtration device of claim 7, wherein the second pipe is sealed at one of the first end, the second end, and the first end and the second end with a sealing ring.

9. The well filtration device of claim 8, wherein the first pipe and the second pipe are made of a thermoplastic unplasticized polyvinyl chloride (UPVC) material.

10. The well filtration device of claim 9, wherein the plurality of openings throughout the second pipe (outer cover pipe) are filtration slots.

11. The well filtration device of claim 10, wherein the filtration slots are lengthwise openings through the second pipe.

12. The well filtration device of claim 11, wherein the first pipe reinforces the strength of the second pipe from external loads and internal pressure.

13. A well filtration system comprising:
a plurality of first pipes, each first pipe comprising:
a first end having a first thickness and first opening diameter;
a second end having a second thickness and a second opening diameter, and
a plurality of openings through a portion of the first pipe; and
a plurality of second pipes, each second pipe comprising:
a first end having a third thickness and a third opening diameter;
a second end having the third thickness and the third opening diameter;
a plurality of openings throughout the second pipe; and
a plurality of reinforcement portions throughout the second pipe;
wherein the second pipe is configured to couple over the first pipe to allow filtration of a liquid.

14. The well filtration system of claim 13, wherein the first end of each first pipe is a female end including threads along an inner portion of the first pipe.

15. The well filtration system of claim 14, wherein the second end of each first pipe is a male end including threads along an outer portion of the first pipe.

16. The well filtration system of claim 13, wherein the first pipes are inner base pipes and the second pipes are outer cover pipes.

17. The well filtration system of claim 16, wherein the plurality of first pipes are configured to connect to one another by threading the female end and the male end together forming a joint configuration.

18. The well filtration system of claim 17, wherein the joint configuration of one internal base pipe male end with another internal base pipe female end with out any gap between the two internal base pipes, creates a compression load bearing characteristic for assembly into deep well.

19. The well filtration system of claim 15, wherein the plurality of openings of the second pipe are filtration slots that allow a liquid outside of the second pipe to pass through to the inner portion of the first pipe.

20. The well filtration system of claim 13, wherein the reinforcement portions are ribs along a length of an inner portion of the second pipe having a thickness such that a gap is formed between a particular first pipe and a particular second pipe when the first pipe is placed within the second pipe.

21. The well filtration system of claim 20, wherein each second pipe is sealed at one of the first end and the second end with a sealing ring.

22. The well filtration system of claim 21, wherein each first pipe and each second pipe are made of a thermoplastic unplasticized polyvinyl chloride (UPVC) material.

23. The well filtration system of claim 22, wherein the plurality of openings throughout each second pipe are filtration slots.

24. The well filtration system of claim 23, wherein the filtration slots are lengthwise openings through each second pipe.

25. The well filtration system of claim 13, wherein each second pipe reinforces the strength of each first pipe from external loads and internal pressure.

26. A well filtration method comprising:
forming a plurality of filtration units by attaching a plurality of inner base pipes with a plurality of outer cover pipes;
coupling the plurality of filtration units together to form a contiguous filtration pipe;
coupling a guide shoe to a first end of the filtration pipe;
inserting the filtration pipe into a well containing liquid; and
filtering the liquid through the filtration pipe,
wherein each inner base pipe comprising:
a first end having a first thickness and first opening diameter;
a second end having a second thickness and a second opening diameter, and
a plurality of openings through a portion of the inner base pipe; and
each outer cover pipe comprising:
a first end having a third thickness and a third opening diameter;
a second end having the third thickness and the third opening diameter;
a plurality of openings throughout the outer cover pipe; and
a plurality of reinforcement portions throughout the outer cover pipe.

27. The well filtration method of claim 26, further comprising:
a gap that is formed by spacing between the reinforcement portions and the exterior of the inner base pipe for the accumulation of filtered water.

28. The well filtration method of claim 27, wherein the reinforcement portions are ribs along a length of an inner portion of the outer cover pipe having a thickness such that the gap is formed between a particular inner base pipe and a particular outer cover pipe when the outer cover pipe is coupled over the inner base pipe.
